(19) United States
(12) Patent Application Publication
(10) Pub. No.: US 2025/0061448 A1
(43) Pub. Date: Feb. 20, 2025

(54) MITIGATION OF TRANSACTION DELAY RISK

(71) Applicant: The Toronto-Dominion Bank, Toronto (CA)

(72) Inventors: Milos DUNJIC, Oakville (CA); David Samuel TAX, Toronto (CA); Jonathan Joseph PRENDERGAST, West Chester, PA (US); Hitesh BAJAJ, Duluth, GA (US); Kenneth Tien Poh WONG, Oakville (CA)

(73) Assignee: The Toronto-Dominion Bank, Toronto (CA)

(21) Appl. No.: 18/451,296

(22) Filed: Aug. 17, 2023

(51) Int. Cl. G06Q 20/38; G06Q 20/02; G06Q 20/20; G06Q 20/40

(52) U.S. Cl. CPC G06Q 20/3821; G06Q 20/027; G06Q 20/20; G06Q 20/401; G06Q 2220/00

(57) ABSTRACT

Systems and methods for mitigating transaction delay risk are provided. A system may receive transaction data, including at least a transaction amount, associated with a transaction. The system may then obtain transfer credentials associated with a value transfer card, send a request for a pre-authorization hold of the transaction amount using the transfer credentials, and initiate a timer. The system may then monitor a blockchain address for receipt of cryptocurrency associated with the transaction. When the cryptocurrency is received prior to an expiration of a time period associated with the timer, the system may release at least a portion of the pre-authorization hold. When the cryptocurrency is not received prior to an expiration of a time period associated with the timer, the system may settle the pre-authorization hold.

### TECHNICAL FIELD

The present application relates to reserving data resources and, more particularly, to systems and methods for reserving data resources to mitigate transaction delay risk associated with cryptocurrency transactions.

### BACKGROUND

Despite the present enthusiasm for cryptocurrencies, they have yet to gain much popularity as a means for day-to-day transactions. For example, cryptocurrencies are not commonly used in point-of-sale (POS) transactions or in ordinary online transactions.

While the completion of traditional transactions may be virtually instantaneous, cryptocurrency transactions are associated with a delay between initiation and completion. This delay may partially account for the present limited use of cryptocurrency. For example, such delays may be problematic in contexts such as in-person, retail environments where transactions must be completed with a steady cadence. Furthermore, due to the volatility of cryptocurrencies, merchants may be concerned that an accepted amount of cryptocurrency may lose value between the time of sale and the time of completion of the cryptocurrency transaction. There may also be concern due to the possibility of a non-completion of a cryptocurrency transfer.

Improvements to the field are desired.

### BRIEF DESCRIPTION OF THE DRAWINGS

Embodiments are described in detail below, with reference to the following drawings:

FIG. 1 is a schematic diagram illustrating an operating environment of an example embodiment;

FIG. 2 is high-level schematic diagram of a computing device;

FIG. 3 shows a simplified organization of software components stored in a memory of the computing device of FIG. 2;

FIG. 4 shows the front of a client device;

FIG. 5 shows the front of a POS terminal;

FIG. 6 illustrates a method for using a pre-authorization hold as transfer guarantee for a cryptocurrency transaction;

FIG. 7 illustrates a first example user interface displayed on a client device; and

FIG. 8 illustrates a second example user interface displayed on a client device.

Like reference numerals are used in the drawings to denote like elements and features.

### DETAILED DESCRIPTION OF VARIOUS EMBODIMENTS

In accordance with an aspect of the present disclosure, there is provided a computer system. The computer system comprises a processor and a memory coupled to the processor. The memory stores instructions that, when executed by the processor, cause the computer system to: receive transaction data associated with a transaction, the transaction data including at least a transaction amount; obtain transfer credentials associated with a value transfer card; send a request for a pre-authorization hold of the transaction amount using the transfer credentials; initiate a timer; and monitor a blockchain address for receipt of cryptocurrency associated with the transaction. When the cryptocurrency is received prior to an expiration of a time period associated with the timer, the processor is configured to release at least a portion of the pre-authorization hold. When the cryptocurrency is not received prior to the expiration of the time period associated with the timer, the processor is configured to settle the pre-authorization hold.

In some implementations, the request for the pre-authorization hold includes a flag indicating an acceptability of one or more forms of cryptocurrency.

In some implementations, the request for the pre-authorization hold includes the blockchain address.

In some implementations, the request for the pre-authorization hold includes a transaction identifier.

In some implementations, the request for the pre-authorization hold includes an indication of a commensurate amount of cryptocurrency associated with the transaction amount.

In some implementations, prior to initiating the timer, the processor is further configured to generate a barcode representing the blockchain address and a transaction identifier.

In some implementations, prior to releasing at least the portion of the pre-authorization hold, the processor is further configured to determine that the received cryptocurrency is equal to a commensurate amount of cryptocurrency associated with the transaction. Releasing at least the portion of the pre-authorization hold includes releasing an entirety of the pre-authorization.

In some implementations, prior to releasing at least the portion of the pre-authorization hold, the processor is further configured to determine that the received cryptocurrency is less than a commensurate amount of cryptocurrency associated with the transaction. The at least the portion of the pre-authorization hold corresponds to an amount of the pre-authorization hold proportionate to the received cryptocurrency.

In some implementations, the transaction data and the transfer credentials are received from an electronic transfer gateway.

In some implementations, the transaction data and the transfer credentials are received from a point-of-sale (POS) terminal.

In some implementations, prior to initiating the timer, the processor is further configured to provide a notification to the POS terminal indicating that the transaction has been approved.

In accordance with another aspect of the present disclosure, there is a method. The method comprises receiving transaction data associated with a transaction. The transaction data includes at least a transaction amount. The method further comprises obtaining transfer credentials associated with a value transfer card; sending a request for a pre-authorization hold of the transaction amount using the transfer credentials; initiating a timer; and monitoring a blockchain address for receipt of cryptocurrency associated with the transaction. When the cryptocurrency is received prior to an expiration of a time period associated with the timer, the method further comprises releasing at least a portion of the pre-authorization hold. When the cryptocurrency is not received prior to the expiration of the time period associated with the timer, the method further comprises settling the pre-authorization hold.

In some implementations, the request for the pre-authorization hold includes a flag indicating an acceptability of one or more forms of cryptocurrency.

In some implementations, the request for the pre-authorization hold includes the blockchain address.

In some implementations, the request for the pre-authorization hold includes a transaction identifier.

In some implementations, the request for the pre-authorization hold includes an indication of a commensurate amount of cryptocurrency associated with the transaction amount.

In some implementations, prior to initiating the timer, the method further comprises generating a barcode representing the blockchain address and a transaction identifier.

In some implementations, prior to releasing at least the portion of the pre-authorization hold, the method further comprises determining that the received cryptocurrency is equal to a commensurate amount of cryptocurrency associated with the transaction. Releasing at least the portion of the pre-authorization hold includes releasing an entirety of the pre-authorization.

In some implementations, prior to releasing at least the portion of the pre-authorization hold, the method further comprises determining that the received cryptocurrency is less than a commensurate amount of cryptocurrency associated with the transaction. The at least the portion of the pre-authorization hold corresponds to an amount of the pre-authorization hold proportionate to the received cryptocurrency.

In some implementations, prior to initiating the timer, the method further comprises providing a notification to a POS terminal indicating that the pre-authorization hold has been approved.

In accordance with yet another aspect of the present disclosure, there is provided a non-transitory computer readable storage medium. The non-transitory computer readable storage medium comprises processor-executable instructions which, when executed, configure a processor to: receive transaction data associated with a transaction, the transaction data including at least a transaction amount; obtain transfer credentials associated with a value transfer card; send a request for a pre-authorization hold of the transaction amount using the transfer credentials; initiate a timer; and monitor a blockchain address for receipt of cryptocurrency associated with the transaction. When the cryptocurrency is received prior to an expiration of a time period associated with the timer, the processor is configured to release at least a portion of the pre-authorization hold. When the cryptocurrency is not received prior to the expiration of the time period associated with the timer, the processor is configured to settle the pre-authorization hold.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Example embodiments of the present application are not limited to any particular operating system, system architecture, mobile device architecture, server architecture, or computer programming language.

A system may provide for the use of a pre-authorization hold as a transfer guarantee for cryptocurrency transactions. For example, a merchant may provide a customer with an option to satisfy a transaction amount using cryptocurrency after a pre-authorization hold has been placed in connection with a value transfer card. If a cryptocurrency transaction of sufficient value has not been completed within a predetermined period of time, the pre-authorization hold will be completed by the merchant. If a cryptocurrency transaction is completed during the predetermined period of time, but the value of the cryptocurrency transaction is not commensurate with the transaction amount, the pre-authorization hold may be settled for a value corresponding to the outstanding transaction amount.

The pre-authorization hold may act as a guarantee of payment, and provide for a steady cadence of a check-out queue of customers.

A customer may be provided with the ability to initiate a cryptocurrency transaction in a variety of ways. For example, the value transfer card issuer may obtain a blockchain address and a transaction identifier via the request for a pre-authorization hold, and may provide means for initiating a blockchain transaction via an application of a client device. Additionally or alternatively, the customer may scan a barcode (e.g., a quick-response (QR) code) displayed at a POS terminal that encodes a blockchain address and a transaction identifier.

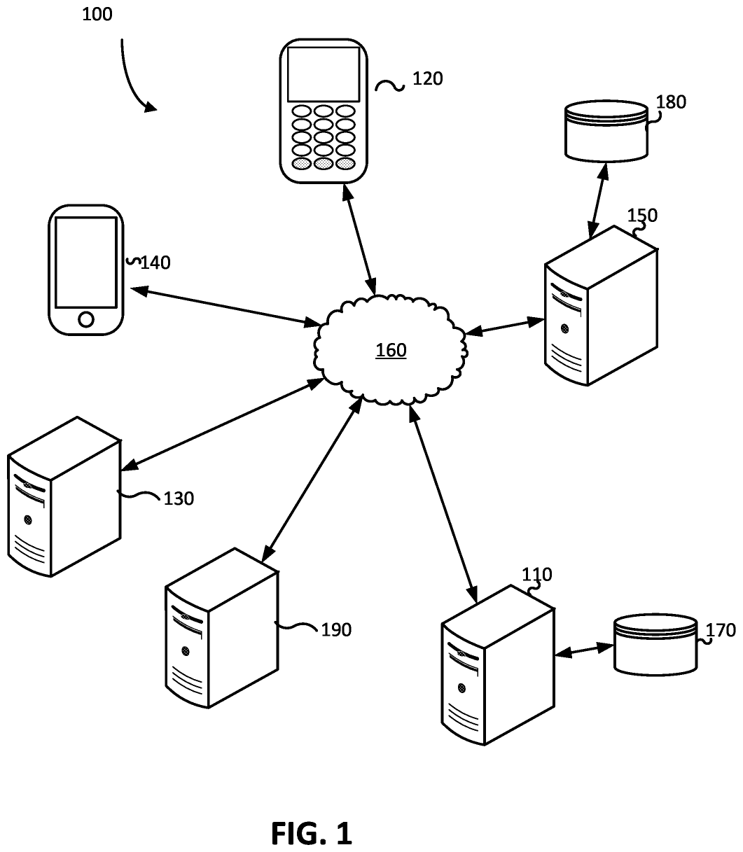

FIG. 1 is a schematic operation diagram illustrating an operating environment of an example embodiment.

As illustrated, the operating environment 100 includes a first database management system 110, a second database management system 150, a transfer rail 130, a POS terminal 120, the transfer initiation system 190, and a client device 140 in communication via a network 160.

Each of the first database management system 110, the second database management system 150, the transfer rail 130, the POS terminal, the transfer initiation system 190, and the client device 140, may be in geographically disparate locations. Put differently, one or more of the first database management system 110, the second database management system 150, the transfer rail 130, the POS terminal, the transfer initiation system 190, and the client device 140 may be remote to others of the first database management system 110, the second database management system 150, the transfer rail 130, the POS terminal, the transfer initiation system 190, and the client device 140.

The first database management system 110, the second database management system 150, the transfer rail 130, the POS terminal, the transfer initiation system 190, and the client device 140 may each be both a computer system and a computing device.

The first database management system 110 and the second database management system 150 may each be a single server, multiple servers, a server farm, or any other such arrangement of computing devices to implement computing server-like functionality. In some embodiments, the first database management system 110 and the second database management system 150 may track, manage, and maintain resources belonging to respective entities, such as the first and second entity. The resources may include owned resources and/or borrowed resources and may be represented in a database. For example, the first database management system 110 may be coupled to a first database 170 which may be provided in secure storage, and the second database management system 150 may be coupled to a second database 180 which may also be provided in secure storage. The secure storage(s) may be provided internally within the first and second database management systems 110, 150 or externally. The secure storage(s) may, for example, be provided remotely from the first and second database management systems 110, 150. For example, the secure storage(s) may include one or more data centers. The data centers may, for example, store data with bank-grade security.

In some embodiments, the first and second database management systems 110, 150 may, for example, be financial institution servers. In some embodiments, the first database management system and the second database management system may be the same system.

In some embodiments, the client device 140 may, as illustrated, be a personal computer such as a smart phone. However, the client device 140 may be a computing device of another type such as a laptop computer, a desktop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments. In certain embodiments, the client device 140 may be associated with one or more users. The one or more users may be, or may be associated with, the first entity, and may have resources associated with the first database management system 110. In some implementations, a user may operate the client device 140 to cause the client device 140 to perform one or more operations consistent with the disclosed embodiments. In some embodiments, the client device 140 may include a smart card, chip card, integrated circuit card (ICC), and/or other card having an embedded integrated circuit.

The client device 140 may include a stored representation of a value transfer card. For example, a token may be stored in secure memory of the client device 140 to allow the client device 140 to be used in initiating a resource transfer. In some implementations, the client device may include a near field communication (NFC) subsystem which may be used to send a token to the POS terminal 120 in order to initiate or complete a resource transfer. Additionally or alternatively, the client device may include a near field communication (NFC) subsystem which may be used to read NFC tags, such as a QR code.

In some embodiments, the client device 140 may initiate a resource transfer via the transfer initiation system 190 and/or the POS terminal 120. In such embodiments, either or both of the transfer initiation system 190 and/or the POS terminal 120 may then communicate with the transfer rail server 130. While a single transfer rail 130 is illustrated in FIG. 1, in practice, the transfer initiation system 190 and/or the POS terminal 120 may communicate with multiple transfer rails.

The transfer initiation system 190 may be or may include, for example, one or more electronic commerce (i.e., e-commerce) systems. An e-commerce system may be, for example, a server associated with an electronic commerce website such as an online store that sells or facilitates the sale of goods and/or services online. The transfer initiation system 190 may include one or more electronic transfer gateways, which may be payment gateways. As noted, the transfer initiation system 190 may communicate with the transfer rail server 130 to initiate a data resource transfer.

The POS terminal 120 is associated with an acquirer and the communication between the POS terminal 120 and the transfer rail server 130 may be by way of a back-end acquirer system. The POS terminal 120 may be located at a location that is associated with the second entity, which may be a merchant. By way of example, the merchant may be a store, restaurant, gym, etc. The acquirer is a merchant bank that accepts deposits associated with transactions made at the point-of-sale terminal and facilitates settlement and deposit of those deposits into an account associated with the merchant.

After a transfer rail 130 is identified, the transfer initiation system 190 and/or the POS terminal/acquirer system sends the transfer rail 130 a message. The message may be sent through a network, such as the network 160. The message includes a transaction amount representing an amount of resources that are to be transferred to complete a resource transfer and physical token data such as a primary account number (PAN) associated with a physical token. The transfer rail 130 identifies an associated issuer based on the physical token data and communicates with the identified issuer to process the resource transfer. More particularly, the transfer rail 130 routes the message received from the transfer initiation system 190 and/or the POS terminal 120 to an issuer system for the identified issuer. The issuer system then determines whether the resource transfer is approved or denied based on pre-defined rules. The rules may, for example, consider any one or more of: whether the cardholder has available resources, etc. The issuer system may be, for example, the first database management system 110.

A resource transfer request may include a request for a pre-authorization hold. The request for the pre-authorization hold may be a request to be reserve a defined amount of resources and may include the transaction amount. By way of example, the request for a pre-authorization hold may define resources that are stored in or otherwise associated with a data record. The resources may represent an amount of value, such as a quantity of a currency. A pre-authorization hold may be described as settled and/or completed when the associated reserved, defined amount of resources have been transferred.

When the issuer system determines whether to approve or deny the request for the pre-authorization hold, it may send a message indicating the result of this determination to the transfer initiation system 190 and/or the POS terminal 120 via the transfer rail 130. The result may then be displayed or otherwise output at the POS terminal 120. The displayed result may indicate an approve response or a decline response. When a request for a pre-authorization hold is approved, a pre-authorization hold may be placed on the defined amount of resources, which may be equal to the transaction amount. In other words, when a request for a pre-authorization hold is approved, the defined amount of resources may be reserved.

The request for the pre-authorization hold may include a transaction identifier. In some embodiments, the request for the pre-authorization hold may include a flag indicating that the second entity is willing to accept a transfer of cryptocurrency in lieu of the transaction amount and may further include an identification of an amount of cryptocurrency that may be accepted in lieu of the transaction amount. The request for the pre-authorization hold may also define a blockchain address associated with the second entity to which cryptocurrency may be sent. The request for the pre-authorization hold may further indicate which cryptocurrency may be accepted, for example, one or more of Bitcoin, Ethereum, Ripple, etc., may be indicated.

A data transfer request may include a request to transfer data from a first data record to a second data record. The first data record may be associated with an account associated with a first entity and the second data record may be associated with an account associated with a second entity. The transfer rail server 130 may operate as an intermediary between the first database management system 110 and the second database management system 150.

The first database management system 110, the second database management system 150, and/or the client device 140 may interact with a blockchain network. For example, the first database management system, the second database management system 150, and/or the client device 140 may each be a node of a blockchain network or may each interact with a node of the blockchain network. This may allow the first database management system 110, the second database management system 150 and/or the client device 140 to read data from the blockchain network and/or to update the blockchain network.

The blockchain network is a decentralized peer-to-peer network in which nodes may maintain respective copies of an append-only ledger.

The blockchain network may be a permissioned blockchain network in which only authorized nodes are permitted to add blocks to the blockchain. For example, only verified nodes may be granted permission to write to the blockchain. In other examples, the blockchain network may be a permissionless blockchain network.

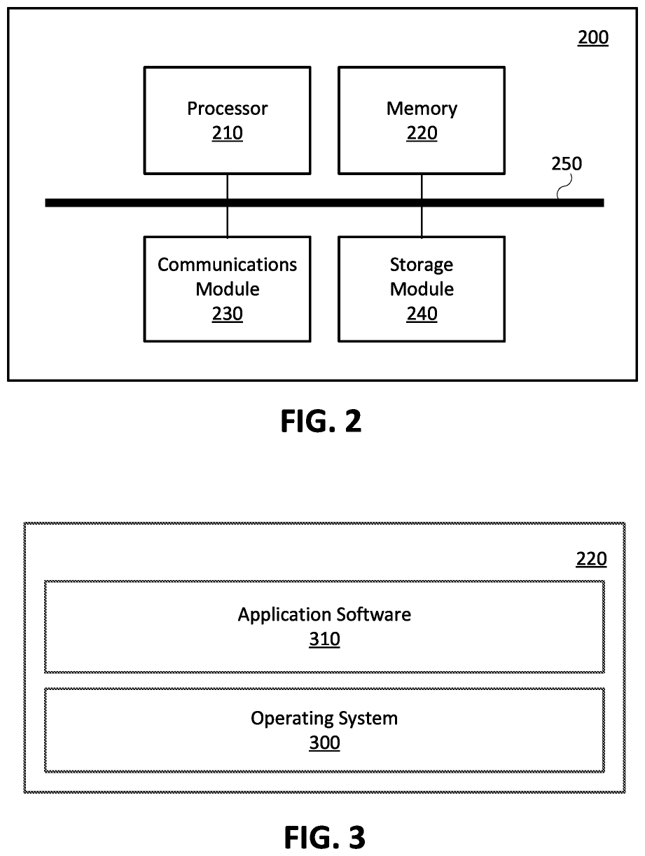

Referring now to FIG. 2. a high-level operation diagram of an example computing device 200 will now be described. The example computing device 200 may be exemplary of the first database management system 110, the client device 140, the second database management system 150, the transfer rail 130, the transfer initiation system 190, and the POS terminal 120.

The example computing device 200 includes numerous different modules. For example, as illustrated, the example computing device 200 may include a processor 210, a memory 220, a communications module 230, and/or a storage module 240. As illustrated, the foregoing example modules of the example computing device 200 are in communication over a bus 250.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.

The communications module 230 allows the example computing device 200 to communicate with other computing devices and/or various communications networks. For example, the communications module 230 may allow the example computing device 200 to send or receive communications signals. Communications signals may be sent or received according to one or more protocols or according to one or more standards. For example, the communications module 230 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 230 may allow the example computing device 200 to communicate using near-field communication (NFC), via WiFi™, using Bluetooth™, or via some combination of one or more networks or protocols. In some embodiments, all or a portion of the communications module 230 may be integrated into a component of the example computing device 200. For example, the communications module may be integrated into a communications chipset.

The storage module 240 allows the example computing device 200 to store and retrieve data. In some embodiments, the storage module 240 may be formed as a part of the memory 220 and/or may be used to access all or a portion of the memory 220. Additionally, or alternatively, the storage module 240 may be used to store and retrieve data from persisted storage other than the persisted storage (if any) accessible via the memory 220. In some embodiments, the storage module 240 may be used to store and retrieve data in a database. A database may be stored in persisted storage. Additionally, or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely. The storage module may also be referred to as a data store.

Software comprising instructions is executed by the processor 210 from a computer-readable medium. For example, software may be loaded into random-access memory from persistent storage of the memory 220. Additionally, or alternatively, instructions may be executed by the processor 210 directly from read-only memory of the memory 220.

The computing device 200 will include other components apart from those illustrated in FIG. 2 and the specific component set may differ based on whether the computing device 200 is operating as the first database management system 110, the client device 140, the second database management system 150, the transfer rail 130, and/or the POS terminal 120. For example, the computing device 200 may include one or more input modules, which may be in communication with the processor 210 (e.g., over the bus 250). The input modules may take various forms including, for example, a mouse, a microphone, a camera, a touchscreen overlay, a button, a sensor, etc. By way of further example, the computing devices 200 may include one or more output modules, which may be in communication with the processor 210 (e.g., over the bus 250). The output modules include one or more display modules which may be of various types including, for example, liquid crystal displays (LCD), light emitting diode displays (LED), cathode ray tube (CRT) displays, etc. By way of further example, the output modules may include a speaker.

Where the computing device 200 is operating as the POS terminal 120, the computing device 200 may include a physical token reader. The physical token reader is configured for reading a physical token such as a value transfer card or a mobile device having a representation of a value transfer card stored thereon. The physical token reader may be or include a card slot which facilitates communication with the physical token through physical contact and/or a contactless reader such as a near field communication (NFC) reader which may facilitate communication with the physical token through communication protocols that do not rely on physical contact with the physical token.

As noted above, the computing device 200 may include one or more input modules and/or one or more output modules. For example, where the computing device 200 is operating as the POS terminal 120 it may include one or more input modules such as a touchscreen display and/or a keypad that may be configured to receive user input. Where the computing device 200 is operating as the POS terminal 120, it may also include a display module which is used for displaying a user interface that facilitates payment processing.

The input and output modules and communications module are devices and may include, for example, hardware components, circuits and/or chips.

FIG. 3 depicts a simplified organization of software components stored in the memory 220 of the example computing device 200 (FIG. 2). As illustrated, these software components include an operating system 300 and an application software 310.

The operating system 300 is software. The operating system 300 allows the application software 310 to access the processor 210 (FIG. 2), the memory 220, and the communications module 230 of the example computing device 200 (FIG. 2). The operating system 300 may be, for example, Google™ Android™, Apple™ iOS™, UNIX™, Linux™, Microsoft™ Windows™. Apple OSX™ or the like.

The application software 310 adapts the example computing device 200, in combination with the operating system 300, to operate as a device performing a particular function. For example, the application software 310 may cooperate with the operating system 300 to adapt a suitable embodiment of the example computing device 200 to operate as the first database management system 110, the client device 140, the second database management system 150, the transfer rail 130, the transfer initiation system 190, and/or the POS terminal 120.

While a single application software 310 is illustrated in FIG. 3, in operation the memory 220 may include more than one application software 310 and different application software 310 may perform different operations.

Where the example computing device is operating as the client device 140, the application software 310 may be or include an issuer application. The issuer application may configure the client device 140 to interact with the issuer system, which may be the first database management system 110. The issuer application may be, for example, a transfer management application such as a banking application. The banking application may, for example, be configured to display a quantum of value in one or more data records (e.g., display balances), configure or request that operations such as transfers of value (e.g., bill payments, email money transfers and other transfers) be performed, and perform other account management functions.

Where the example computing device is operating as the second database management system, the application software may be or include a timer. The timer may be associated with a time period and may be configured to expire after the time period.

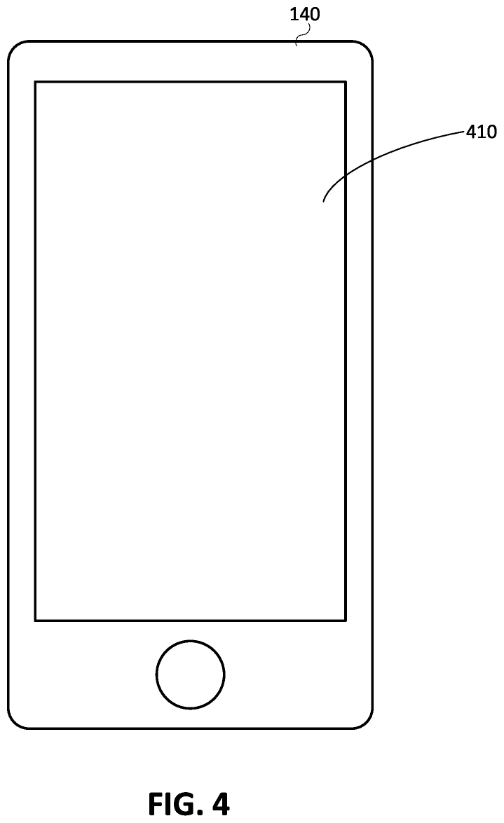

FIG. 4 shows the front of the client device 140 of FIG. 1. The client device 140 may be a personal computing device, such as a smart phone, as shown in FIG. 4. As previously described, the client device 140 may be a computing device of another type such as a laptop computer, a desktop computer, a tablet computer, a notebook computer, a hand-held computer, a personal digital assistant, a portable navigation device, a mobile phone, a wearable computing device.

As illustrated, the front of the client device 140 includes a display 410. The display 410 is a module of the smart phone embodiment of the client device 140. The display 410 is for presenting graphics. The display 410 may be, for example, a liquid crystal display (LCD). The display 410 may be used to display a token. In addition to being an output device, the display 410 may also be an input device. For example, the client device may include a near field communication (NFC) subsystem which may be used to read NFC tags, such as a QR code, via the display 410. As a further example, the display 410 may allow touch input to be provided to the client device 140. In other words, the display 410 may be a touch sensitive display module. In a particular example, the display 410 may be a capacitive touch screen.

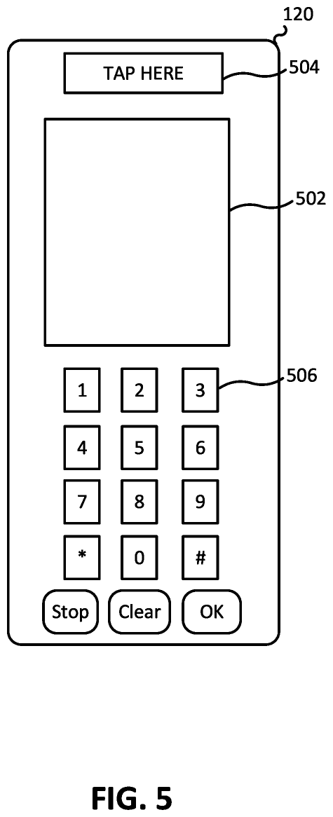

Referring now to FIG. 5, an example POS terminal 120 is illustrated. The POS terminal includes a physical token reader which, in the example, includes a wireless physical token reader configured for near field communications. The physical token reader may be used by tapping a physical token at a particular region 504 of the POS terminal 120. The particular region 504 is a sensing region. That is, when the physical token is placed at or near the particular region, the POS terminal 120 is able to communicate with the physical token to obtain physical token data.

The POS terminal 120 includes one or more output modules. In the example, the output modules include a display module 502. The display module 502 may be used to display one or more NFC tags, such as a barcode (e.g., a QR code). The display module 502 may, in at least some implementations, be a touchscreen display. In such cases, the display module 502 is both an output module and an input module.

The POS terminal 120 may include an input module of another type instead of or in addition to a touchscreen display. By way of example, the displayed POS terminal 120 includes a keypad 506. The input module may be used by an operator in order to setup a transaction.

By way of further example, in some instances, the POS terminal 120 may be associated with a computer system which allows an operator to input order information that may be used to calculate a base amount that is provided directly to the POS terminal 120. For example, the computer system may be a merchant terminal.

The POS terminal 120 may, in some instances, include other physical token readers apart from the wireless physical token reader. For example, a card slot may be included and may be arranged so that when a value transfer card is inserted in the card slot, one or more pins or pads associated with the card may align with pads or pins provided in the POS terminal 120 that are intended for reading data from the card.

By way of further example, in some instances, the physical token readers may include a magnetic reader which is configured for reading data from a magnetic strip associated with a value transfer card.

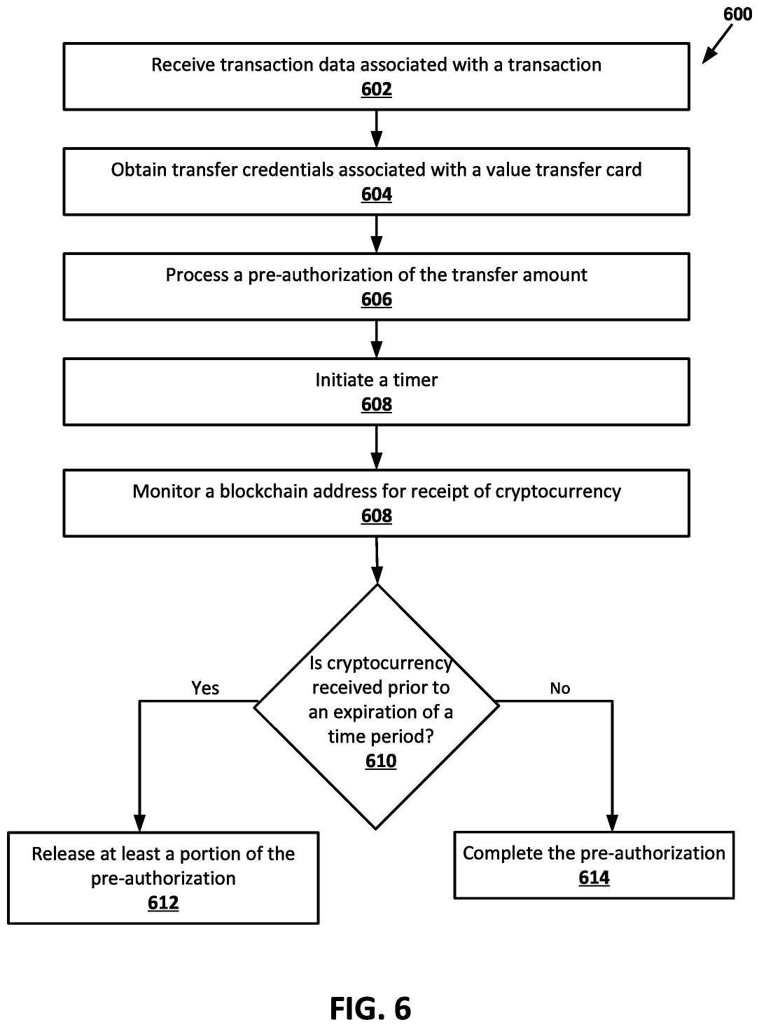

The operation of the second database management system 150 (FIG. 1) will now be described with reference to the flowchart of FIG. 6 which illustrates a method 600 for method for using a pre-authorization hold as transfer guarantee for a cryptocurrency transaction. Operations 602 and onward are performed by one or more processors of a computing device, such as for example the processor 210 of a suitably configured instance of the example computing device 200, executing software such as, for example, a suitable instance of the application 310.

At the operation 602, the second database management system receives transaction data associated with a transaction. The transaction data may include at least a transaction amount. The transaction data may be received, for example, via the POS terminal 120 (FIG. 1) or from the transfer initiation system 190.

At the operation 604, the system obtains transfer credentials associated with a value transfer card. The transfer credentials may include, for example, the primary account number (PAN), expiry date, and/or verification number for the value transfer card. The transaction data may be received, for example, via the POS terminal 120 (FIG. 1) or via the transfer initiation system 190.

At the operation 606, the system sends a request for a pre-authorization hold of the transaction amount using the transfer credentials. The request for a pre-authorization hold may be sent to the first database management system.

As noted, a request for a pre-authorization hold may be a request to reserve a defined amount of resources and may include the transaction amount. By way of example, the request for a pre-authorization hold may define resources that are stored in or otherwise associated with a data record. The resources may represent an amount of value, such as a quantity of a currency.

As further noted, the request for a pre-authorization hold may include a transaction identifier.

In some embodiments, the request for a pre-authorization hold may include a flag indicating that the second entity is willing to accept a transfer of cryptocurrency in lieu of the transaction amount and may further include indicate one or more types of cryptocurrency which may be accepted. For example, the request may indicate Bitcoin, Ethereum, Ripple, etc.

In some embodiments, the request for a pre-authorization hold may include an identification of one or more commensurate amounts of cryptocurrency that may be accepted in lieu of the transaction amount. The one or more commensurate amounts of cryptocurrency may correspond to the one or more accepted types of cryptocurrency. In some implementations, for example, the system may use an exchange rate to determine the one or more commensurate amounts of cryptocurrency that may be accepted in lieu of the transaction amount. For example, the transaction amount may be defined by a first currency unit and a type of cryptocurrency may be defined by a second currency unit. An exchange rate may be determined with respect to the first currency unit and the second currency unit. The system may use one or more exchange rates to determine one or more commensurate amounts of cryptocurrency that may be accepted in lieu of the transaction amount.

The request for a pre-authorization hold may also define a blockchain address associated with the second entity to which cryptocurrency may be sent. In some embodiments, the blockchain address may provide an indication that the second entity is willing to accept cryptocurrency.

The system may provide the blockchain address to the first entity in a variety of ways. For example, the system may generate a barcode representing the blockchain address to which cryptocurrency may be sent. The barcode may be, for example, a linear barcode or a matrix (2D) barcode, such as a QR code. The system may display the barcode at the display module 502 (FIG. 5) of the POS terminal 120 (FIG. 5). The barcode may encode the blockchain address and the transaction identifier.

The barcode may then be scanned by the client device 140 (FIG. 1). Upon scanning the barcode, the client device may display options for providing cryptocurrency to the second entity.

Additionally or alternatively, the system may provide the blockchain address to the first entity via the request for a pre-authorization hold. For example, the request for a pre-authorization hold may include a flag that indicates that the second entity accepts cryptocurrency, and it may define an associated blockchain address. In some embodiments, the first entity's transfer card issuer, (which may be the first database management system 110 (FIG. 1)), may read such data in the request for a pre-authorization hold and may notify the first entity that cryptocurrency may be used to complete the transaction. In some embodiments, the first entity's transfer card issuer may notify the first entity of the blockchain address. In some embodiments, the first entity's transfer card issuer may provide, to the first entity, means for initiating a cryptocurrency transfer to the blockchain address. For example, the first entity may be provided with a uniform resource locator (URL) link via an application operating on the client device (FIG. 4). The URL may operate to share the blockchain address with a cryptocurrency wallet provider, for example.

In some embodiments, subsequent to sending a request for a pre-authorization hold, the system provides a notification to the POS terminal indicating that the transaction has been approved. In some implementations, in a brick-and-mortar environment, the notification indicating that the transaction has been approved signals a successful checkout of the instant customer allowing for checkout to proceed to the next customer in line. In this way, a customer may be considered to have successfully checked out and a next person in line may proceed to checkout. The customer may then, optionally, initiate a cryptocurrency transaction, e.g., via an application operating on the client device and/or via scanning a barcode displayed on a point-of-sale terminal that encodes the cryptocurrency address and a transaction identifier.

At the operation 608, the system initiates a timer. The timer may be associated with a time period and may be configured to expire after the time period. For example, the timer may be configured to expire after a time period of between two hours and twenty-four hours, for example.

At the operation 610, the system monitors a blockchain address for receipt of cryptocurrency associated with the transaction. In some embodiments, the monitored blockchain address may be the blockchain address identified in the request for a pre-authorization hold. The system then determines whether cryptocurrency is received prior to the expiration of the time period, associated with the timer at the operation 612.

When the system determines, at the operation 610, that cryptocurrency is received prior to an expiration of a time period associated with the timer, the system proceeds to the operation 612.

At the operation 612, the system releases at least a portion of the pre-authorization hold. For example, in some embodiments, the system may use an exchange rate to determine the value of the transferred amount of cryptocurrency relative to the transaction amount. For example, the transaction amount may be defined by a first currency unit and the transferred amount of cryptocurrency may be defined by a second currency unit, and an exchange rate may be determined with respect to the first currency unit and the second currency unit. The system may use the exchange rate to determine the value of the transferred amount of cryptocurrency relative to the transaction amount. In some embodiments, if the value of the transferred amount of cryptocurrency is greater than or equal to the transaction amount, the system may release the entirety of the pre-authorization hold.

Alternatively, if the value of the transferred amount of cryptocurrency is less than the transaction amount, the system may release a portion of the pre-authorization hold. As a result, the pre-authorization hold will be sustained for a remaining portion of the transaction amount. In some implementations, the portion of the pre-authorization hold that is released may be equal to the value of the transferred amount of cryptocurrency. In this way, the sum of the remaining portion and the value of the transferred amount of cryptocurrency may be equal to the value of the transaction amount.

When the system determines, at the operation 610, that cryptocurrency is not received prior to an expiration of a time period, the system proceeds to the operation 614.

At the operation 614, the system settles the pre-authorization hold for the transaction amount. As noted, a pre-authorization hold may be described as settled and/or completed when the associated reserved, defined amount of resources have been transferred. In this way, in the event that a cryptocurrency transaction is not completed within a predefined period of time, the transaction amount will be received.

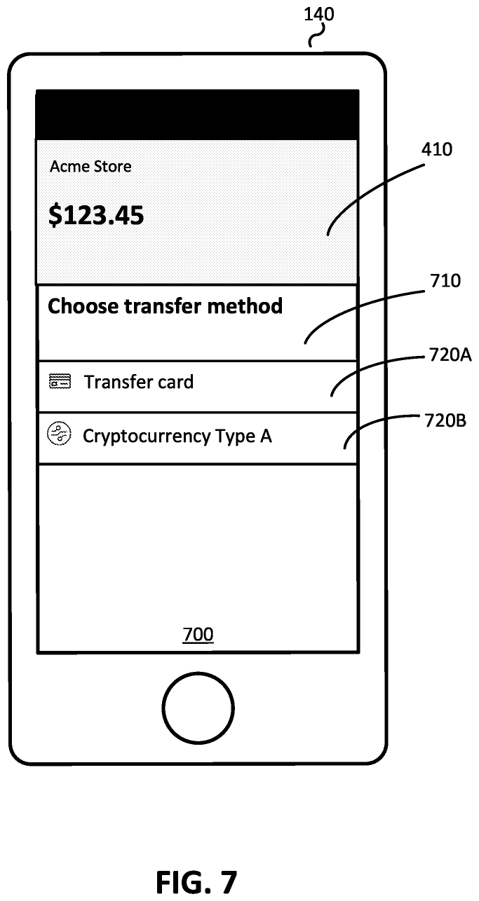

FIG. 7 shows a first example user interface displayed on a client device 140 for use in presenting a notification that cryptocurrency may be used to complete a transaction. As shown, the user interface also provides a means for initiating a cryptocurrency transaction. The user interface may be provided by an issuer application operating on the client device 140. For example, the value transfer card issuer may obtain a blockchain address and a transaction identifier via the request for a pre-authorization hold, and may provide this information to an application of a client device.

As illustrated, the display 410 of the client device 140 may present a first example user interface 700. The first example user interface 700 includes an indication of the transaction amount ($123.45), the name of the second entity (“Acme Store”), a prompt 710 (“Choose transfer method”) and a set of selectable options 720A-720B.

The first selectable option 720A (“Transfer card”) provides for the transfer of the transaction amount using a value transfer card. The second selectable option 720B (“Cryptocurrency Type A”) provides for the initiation of a cryptocurrency transaction in lieu of a transfer of the transaction amount. In some implementations, the set of selectable options 720A-720B may include multiple selectable options related to the initiation of a cryptocurrency transaction. For example, the set of selectable options may include selectable options corresponding to each of a number of types of cryptocurrencies (e.g., Bitcoin, Ethereum, Ripple, etc.).

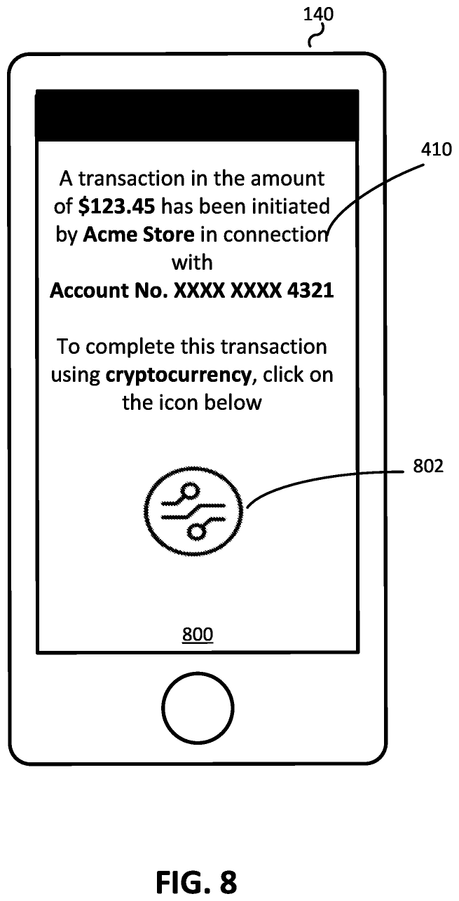

FIG. 8 shows a second example user interface displayed on a client device 140 for use in presenting a notification that cryptocurrency may be used to complete a transaction. As shown, the user interface also provides a means for initiating a cryptocurrency transaction. The user interface may be provided by an application operating on the client device 140 in response to scanning a barcode displayed on the display module 502 (FIG. 5) of the POS terminal 120 (FIG. 5) subsequent to the approval of a request for a pre-authorization hold.

As illustrated, the display 410 of the client device 140 may present a second example user interface 800. The second example user interface 800 includes an indication of the transaction amount “($123.45”), the name of the second entity (“Acme Store”), an identification of an account (“Account No. XXXX XXXX 4321”), a prompt (“To complete this transaction using cryptocurrency, click on the icon below”), and a cryptocurrency icon 802.

Selection of the cryptocurrency icon 802 may provide for the initiation of a cryptocurrency transaction in lieu of a transfer of the transaction amount. In some implementations, a plurality of cryptocurrency icons 802 may be displayed by the second example user interface 800, and each cryptocurrency icon 802 may be associated a different type of cryptocurrency. In this way, a user may be provided with the option to complete a transaction using one or more types of cryptocurrency (e.g., Bitcoin, Ethereum, Ripple, etc.).

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a processor; and
a memory coupled to the processor and storing instructions that, when executed by the processor, cause the computer system to:
receive transaction data associated with a transaction, the transaction data including at least a transaction amount;
obtain transfer credentials associated with a value transfer card;
send a request for a pre-authorization hold of the transaction amount using the transfer credentials;
initiate a timer;
monitor a blockchain address for receipt of cryptocurrency associated with the transaction; and
when the cryptocurrency is received prior to an expiration of a time period associated with the timer:
release at least a portion of the pre-authorization hold.

2. The system of claim 1, wherein the system is further caused to:
when the cryptocurrency is not received prior to the expiration of the time period associated with the timer:
settle the pre-authorization hold.

3. The system of claim 1, wherein the request for the pre-authorization hold includes a flag indicating an acceptability of one or more forms of cryptocurrency.

4. The system of claim 1, wherein the request for the pre-authorization hold includes the blockchain address.

5. The system of claim 1, wherein the request for the pre-authorization hold includes a transaction identifier.

6. The system of claim 1, wherein the request for the pre-authorization hold includes an indication of a commensurate amount of cryptocurrency associated with the transaction amount.

7. The system of claim 1, wherein, prior to initiating the timer, the processor is further configured to:
generate a barcode representing the blockchain address and a transaction identifier.

8. The system of claim 1, wherein prior to releasing at least the portion of the pre-authorization hold, the processor is further configured to:
determine that the received cryptocurrency is equal to a commensurate amount of cryptocurrency associated with the transaction,
wherein releasing at least the portion of the pre-authorization hold includes releasing an entirety of the pre-authorization.

9. The system of claim 1, wherein prior to releasing at least the portion of the pre-authorization hold, the processor is further configured to:
determine that the received cryptocurrency is less than a commensurate amount of cryptocurrency associated with the transaction,
wherein the at least the portion of the pre-authorization hold corresponds to an amount of the pre-authorization hold proportionate to the received cryptocurrency.

10. The system of claim 1, wherein the transaction data and the transfer credentials are received from an electronic transfer gateway.

11. The system of claim 1, wherein the transaction data and the transfer credentials are received from a point-of-sale (POS) terminal.

12. The system of claim 11, wherein prior to initiating the timer, the processor is further configured to:
provide a notification to the POS terminal indicating that the transaction has been approved.

13. A method comprising:
receiving transaction data associated with a transaction, the transaction data including at least a transaction amount;
obtaining transfer credentials associated with a value transfer card;
sending a request for a pre-authorization hold of the transaction amount using the transfer credentials;
initiating a timer;
monitoring a blockchain address for receipt of cryptocurrency associated with the transaction; and
when the cryptocurrency is received prior to an expiration of a time period associated with the timer:
releasing at least a portion of the pre-authorization hold.

14. The method of claim 13, further comprising:
when the cryptocurrency is not received prior to the expiration of the time period associated with the timer:
settling the pre-authorization hold.

15. The method of claim 13, wherein the request for the pre-authorization hold includes a flag indicating an acceptability of one or more forms of cryptocurrency.

16. The method of claim 13, wherein the request for the pre-authorization hold includes the blockchain address.

17. The method of claim 13, wherein the request for the pre-authorization hold includes a transaction identifier.

18. The method of claim 13, wherein the request for the pre-authorization hold includes an indication of a commensurate amount of cryptocurrency associated with the transaction amount.

19. The method of claim 13, wherein, prior to initiating the timer, the method further comprises:
generating a barcode representing the blockchain address and a transaction identifier.

20. A non-transitory computer readable storage medium comprising processor-executable instructions which, when executed, configure a processor to:
receive transaction data associated with a transaction, the transaction data including at least a transaction amount;
obtain transfer credentials associated with a value transfer card;
send a request for a pre-authorization hold of the transaction amount using the transfer credentials;
initiate a timer;
monitor a blockchain address for receipt of cryptocurrency associated with the transaction;
when the cryptocurrency is received prior to an expiration of a time period associated with the timer:
release at least a portion of the pre-authorization hold; and
when the cryptocurrency is not received prior to the expiration of the time period associated with the timer:
settle the pre-authorization hold.
